(19) United States
(12) Patent Application Publication
(10) Pub. No.: US 2022/0380248 A1
(43) Pub. Date: Dec. 1, 2022

(54) GLASS FOR AUTONOMOUS CAR

(71) Applicant: AGC GLASS EUROPE, Louvain-la-Neuve (BE)

(72) Inventors: Meijie LI, Louvain-La-Neuve (BE); Yannick SARTENAER, Vedrin (BE)

(73) Assignee: AGC GLASS EUROPE, Louvain-la-Neuve (BE)

(21) Appl. No.: 17/626,677

(22) PCT Filed: Jul. 17, 2020
(86) PCT No.: PCT/EP2020/070281

§ 371 Date: Jan. 12, 2022

(30) Foreign Application Priority Data
Jul. 18, 2019 (EP) 19186910.6

(51) Int. Cl. C03C 4/10; B60R 11/00; C03C 3/085; C03C 27/10; G01S 17/89; G01S 7/481; G02B 5/20; C03C 4/08

(52) U.S. Cl. CPC C03C 4/10; B60R 11/00; C03C 3/085; C03C 27/10; G01S 17/89; G01S 7/4813; G02B 5/208; C03C 4/082; B60R 2011/0022; B60R 2011/0026; B60R 2011/0036

(57) ABSTRACT

An automotive LiDAR glazing with at least one glass sheet having an absorption coefficient lower than 5 m⁻¹ in the wavelength range from 750 to 1650 nm and having an external face and an internal face. An infrared-based remote sensing device emitting and/or receiving p-polarized laser signal in the wavelength range from 750 to 1650 nm is placed on the internal face of the glass sheet.

The invention concerns a glass comprising an infrared-based remote sensing device and particularly a LiDAR sensor. More particularly, the invention concerns a glass comprising new generation LiDAR sensors emitting and/or receiving p-polarized signal to be integrated in an autonomous car.

Today, the tendency is to use more and more autonomous car to be completely used in the future. For example, futuristic autonomous car, also called driver less car, self-driving car, robotic car, is a vehicle that is capable of sensing its environment and navigating without human input.

Autonomous vehicles detect surroundings using radar, LiDAR (acronym of Light Detection And Ranging), GPS, Odometry, and computer vision. Advanced control systems interpret sensory information to identify appropriate navigation paths, as well as obstacles and relevant signage. Autonomous cars have control systems that are capable of analyzing sensory data to distinguish between different cars on the road, which is very useful in planning a path to the desired destination. Among all detection techniques, LiDAR is a very useful one to offer 3D images with good resolution.

According to the present invention, the infrared-based remote sensing device LiDAR sensors are new generation LIDAR based on scanning, rotating, flashing or solid state LiDARs and enabling 3D mapping the surroundings around the vehicle. Thus, the IR based sensor allows to make precise mapping of the surrounding of the vehicle which is used to drive correctly the autonomous car and to prevent any shock with an obstacle.

LiDAR (also written Lidar, LIDAR or LADAR) is a technology that measures distance by illuminating a target with an infrared (IR) laser light. They are particularly scanning, rotating, flashing or solid state LiDARs. The scanning or rotating LiDARs are using moving lasers beams while flashing and solid state LiDAR emits light pulses which reflect off objects.

LiDAR may be integrated on vehicles as a stand-alone device enclosed by a protective housing comprising at least a portion of the cover lens made of glass, described in patent application WO20190303106. More particularly, this stand-alone device may be added additionally to the car body, e.g. at car roof, or may be embedded into existing car components, like bumper, headlight or rear view mirrors.

For a seamless integration, LiDAR may also be integrated behind existing automotive glazing, like windshield, backlite, or sidelite, described in patent application WO2018015312. More particularly, integration of sensor behind the upper part of the windshield involves other advantages such as a good position for geometrical distance estimation, a better view on the road surface and a good overview on traffic situation. In addition, this locations also offers a recurrent aperture cleaning by the wipers, a low risk for stone scratches, a seamless aesthetic and more generally a better controlled environment to operate the sensor.

Furthermore, LiDAR may be integrated behind glass trim elements, described in patent application WO2018015313. Glass trim for automotive refers to the items that can be added to the interior or exterior of an automobile to increase its appeal or to mask some unaesthetic parts of the automotive. The use of glass trim element also offers the opportunity to add some functionalities as touch functionalities which are no permitted with plastics or others classically used materials. Today, more and more glass trim elements are considered in automotive field. For example such as glass trim elements are used as car trunk cover, cover for A-, B-, C-, D-pillars (vertical or near vertical supports of a car's window area—designated respectively as the A, B, C or (in larger cars) D-pillar, moving from the front to rear, in profile view) or interior trim element on the dashboard, console, door trim. . . .

It is understood that the present invention concerns generally glass used for automotive such as glass for window (windshield, backlite, sidelite . . . ) and trim element used as applique and also cover for automotive LiDAR integration described above. In general, new generations of LiDAR sensors are very demanding on automotive LiDAR glazing in terms of optical properties. More particularly, it requires maximum LiDAR signal transmission through glazing.

Automotive LiDAR glazing has classically two surfaces, the inner surface facing to the sensor and the outer surface facing to the environment. Because of Fresnel reflection, signal is partially lost every time when it passes each of the glazing surface. This signal loss increases as the Angle Of Incidence (AOI) increases, therefore for a sensor with a large field of view and/or a glazing with a big inclined angle regarding to optical axis of the sensor, the signal loss may become too much for the sensor to work sufficiently. Especially for sensors like LiDAR, who need the signal pass the glazing two or more times, the signal loss problem may become even severe.

There are 2 main solutions to reduce surface reflection loss. One solution is to have nice optical coupling between the sensor and the inner surface of the glazing, either by filling up refractive index matching materials or by using optical coupling components. However this solution increases the system complexity and cost, which is not always feasible. Moreover, the optical signal loss at the outer surface of the glazing cannot be reduced.

The other solution is to apply Anti-Reflection (AR) coating on one or both glazing surfaces. However it is mostly difficult or impossible to design an AR coating efficient for all signals with different AOIs and wavelengths, and the cost can be dramatically increased. Furthermore, AR coating reduces the mechanical and chemical resistance, and sometimes it is not possible to be applied at the outer surface of the glazing.

Thus, there is a need for an alternative solution to reduce the surface reflection loss, which is efficient on both surfaces of automotive LiDAR glazing without problems mentioned above.

Thus, the present invention proposes a solution wherein automotive LiDAR glazing (including glass cover, existing automotive glazing and glass trims), can transmit LiDAR signal with reduced surface reflection loss at both surfaces, with minimal integration design change. More particularly, this solution works efficiently for LiDAR signal with a large AOI at glazing surface, therefore for a sensor with a large field of view and/or a glazing with a big inclined angle regarding to optical axis of the sensor.

For simplicity, the numbering of the glass sheets in the following description refers to the numbering nomenclature conventionally used for glazing. Thus, the face of the glazing in contact with the environment outside the vehicle is known as the side 1 and the surface in contact with the internal medium, that is to say the passenger compartment, is called face 2. For a laminated glazing, the glass sheet in contact with the outside environment the vehicle is known as the side 1 and the surface in contact with the internal part, namely the passenger compartment, is called face 4.

For avoidance of doubt, the terms “external” and “internal” refer to the orientation of the glazing during installation as glazing in a vehicle.

Also for avoidance of doubt, the present invention is applicable for all means of transport such as automotive, train, plane . . . but also other vehicles like drones. . . .

Thus, the present invention concerns an automotive LiDAR glazing comprising at least one glass sheet having an absorption coefficient lower than 5 m⁻¹ in the wavelength range from 750 to 1650 nm and having an external face and an internal face.

According to this present invention, an infrared-based remote sensing device emitting and/or receiving p-polarized signal in the wavelength range from 750 to 1650 nm is placed on the internal face of the glass sheet.

According to the invention, the glass sheet has an absorption coefficient lower than 5 m⁻¹ in the wavelength range from 750 to 1650 nm. To quantify the low absorption of the glass sheet in the infrared range, in the present description, the absorption coefficient is used in the wavelength range from 750 to 1650 nm. The absorption coefficient is defined by the ratio between the absorbance and the optical path length traversed by electromagnetic radiation in a given environment. It is expressed in m⁻¹. It is therefore independent of the thickness of the material but it is function of the wavelength of the absorbed radiation and the chemical nature of the material.

In the case of glass, the absorption coefficient (μ) at a chosen wavelength λ can be calculated from a measurement in transmission (T) as well as the refractive index n of the material (thick=thickness), the values of n, ρ and T being a function of the chosen wavelength λ:

$$μ = - \frac{1}{thick} . ln [ \frac{- {( 1 - ρ )}^{2} + \sqrt{{( 1 - ρ )}^{4} + 4. {T}^{2} . {ρ}^{2}}}{2. T . {ρ}^{2}} ] with p = {( n - 1 )}^{2} / {( n + 1 )}^{2} .$$

The glass sheet according to the invention preferably has an absorption coefficient in the wavelength range of 750-1650 nm, generally used in optical technologies relating to the invention, very low compared to conventional glasses (as the said “clear glass” to which such a coefficient is about 30 m⁻¹ order). In particular, the glass sheet according to the invention has an absorption coefficient in the wavelength range from 750 to 1650 nm lower than 5 m⁻¹.

Preferably, the glass sheet has an absorption coefficient of lower than 3 m⁻¹, or even lower than 2 m⁻¹ and, even more preferably lower than 1 m⁻¹, or even lower than 0.8 m⁻¹.

A low absorption presents an additional advantage that the final IR transmission is less impacted by the optical path in the material. It means that for large field of view (FOV) sensors with high aperture angles the intensity perceived at the various angles (in different areas are the image) will be more uniform.

Thus, when an autonomous vehicle encounters an unexpected driving environment unsuitable for autonomous operation, such as road construction or an obstruction, vehicle sensors through the glazing according to the invention can capture data about the vehicle and the unexpected driving environment. The captured data can be sent to a remote operator or to the central intelligence unit. The remote operator or unit can operate the vehicle or issue commands to the autonomous vehicle to be executed on various vehicle systems. The captured data sent to the remote operator/unit can be optimized to conserve bandwidth, such as by sending a limited subset of the captured data.

According to the invention, the glass sheet is made of glass which may belong to different categories with the particularity of having an absorption coefficient lower than 5 m⁻¹ in the wavelength range from 750 to 1650 nm. The glass can thus be a soda-lime-silica type glass, alumino-silicate, boro-silicate,

Preferably, the glass sheet having a high level of near infrared radiation transmission is an extra-clear glass.

Preferably, the base glass composition of the invention comprises a total content expressed in weight percentages of glass:

| | |
|---|---|
| SiO₂ | 55-85% |
| Al₂O₃ | 0-30% |
| B₂O₃ | 0-20% |
| Na₂O | 0-25% |
| CaO | 0-20% |
| MgO | 0-15% |
| K₂O | 0-20% |
| BaO | 0-20%. |

More preferably, the base glass composition comprises according to the invention in a content, expressed as total weight of glass percentages:

| | |
|---|---|
| SiO₂ | 55-78% |
| Al₂O₃ | 0-18% |
| B₂O₃ | 0-18% |
| Na₂O | 0-20% |
| CaO | 0-15% |
| MgO | 0-10% |
| K₂O | 0-10% |
| BaO | 0-5% |

More preferably, for reasons of lower production costs, the at least one glass sheet according to the invention is made of soda-lime glass. Advantageously, according to this embodiment, the base glass composition comprises a content, expressed as the total weight of glass percentages:

| | |
|---|---|
| SiO₂ | 60-75% |
| Al₂O₃ | 0-6% |
| B₂O₃ | 0-4% |
| CaO | 0-15% |
| MgO | 0-10% |
| Na₂O | 5-20% |
| K₂O | 0-10% |
| BaO | 0-5%. |

In addition to its basic composition, the glass may include other components, nature and adapted according to quantity of the desired effect.

A solution proposed in the invention to obtain a very transparent glass in the high infrared (IR), with weak or no impact on its aesthetic or its color, is to combine in the glass composition a low iron quantity and chromium in a range of specific contents.

Thus, according to a first embodiment, the glass sheet preferably has a composition which comprises a content, expressed as the total weight of glass percentages:

| | |
|---|---|
| Fe total (expressed asFe₂O₃) | 0.002-0.06% |
| Cr₂O₃ | 0.0001-0.06%. |

Such glass compositions combining low levels of iron and chromium showed particularly good performance in terms of infrared reflection and show a high transparency in the visible and a little marked tint, near a glass called “extra- clear”. These compositions are described in international applications WO2014128016A1, WO2014180679A1, WO2015011040A1, WO2015011041A1, WO2015011042A1, WO2015011043A1 and WO2015011044A1, incorporated by reference in the present application. According to this first particular embodiment, the composition preferably comprises a chromium content (expressed as Cr2O3) from 0.002 to 0.06% by weight relative to the total weight of the glass. Such contents of chromium it possible to further improve the infrared reflection.

According to a second embodiment, the glass sheet has a composition which comprises a content, expressed as the total weight of glass percentages:

| | |
|---|---|
| Fe total (expressed as Fe₂O₃) | 0.002-0.06% |
| Cr₂O₃ | 0.0015-1% |
| Co | 0.0001-1%. |

Such chromium and cobalt based glass compositions showed particularly good performance in terms of infrared transmission while offering interesting possibilities in terms of aesthetics/color (bluish neutrality to intense coloration even up opacity). Such compositions are described in European patent application No. 13 198 454.4, incorporated by reference herein.

According to a third embodiment, the glass sheets have a composition which comprises a content, expressed as the total weight of glass percentages:

| | |
|---|---|
| total iron (expressed as Fe₂O₃) | 0.02-1% |
| Cr₂O₃ | 0.002-0.5% |
| Co | 0.0001-0.5%. |

Preferably, according to this embodiment, the composition comprises: 0.06%<Total Iron≤1%.

Such compositions based on chromium and cobalt are used to obtain colored glass sheets in the blue-green range, comparable in terms of color and light transmission with blue and green glasses on the market, but with performances particularly good in terms of infrared reflection. Such compositions are described in European patent application EP15172780.7, and incorporated by reference into the present application.

According to a fourth embodiment, the glass sheet has a composition which comprises a content, expressed as the total weight of glass percentages:

| | |
|---|---|
| total iron (expressed as Fe₂O₃) | 0.002-1% |
| Cr₂O₃ | 0.001-0.5% |
| Co | 0.0001-0.5%. |
| Se | 0.0003-0.5%. |

Such glass compositions based on chromium, cobalt and selenium have shown particularly good performance in terms of infrared transmission while offering interesting possibilities in terms of aesthetics / color (gray neutral to slight staining intense in the gray-bronze range). Such compositions are described in the application of European patent EP15172779.9, and incorporated by reference into the present application.

According to a first alternative embodiment, the glass sheet has a composition which comprises a content, expressed as the total weight of glass percentages:

| | |
|---|---|
| total iron (expressed as Fe₂O₃) | 0.002-0.06% |
| CeO₂ | 0.001-1%. |

Such compositions are described in European patent application No. 13 193 345.9, incorporated by reference herein.

According to another alternative embodiment, the glass has a composition which comprises a content, expressed as the total weight of glass percentages:

| | |
|---|---|
| total iron (expressed as Fe₂O₃) | 0.002-0.06%; |

and one of the following components:
manganese (calculated as MnO) in an amount ranging from 0.01 to 1% by weight;
antimony (expressed as Sb₂O₃), in an amount ranging from 0.01 to 1% by weight;
arsenic (expressed as As₂O₃), in an amount ranging from 0.01 to 1% by weight,

or
copper (expressed as CuO), in an amount ranging from 0.0002 to 0.1% by weight.

Such compositions are described in European patent application No. 14 167 942.3, incorporated by reference herein.

According to the present invention, the automotive LiDAR glazing may be in the form of planar sheets. The glazing may also be curved. This is usually the case for automotive glazing as for rear windows, side windows or roofs or especially windshields. Also for glass cover and glass trims, the glass sheet may be totally or partially curved to correctly fit with the particular design of the vehicle and/or to enhance the LiDAR sensor performance.

According to one embodiment of the present invention, the glass sheet may advantageously be chemically or thermally tempered in order to enhance the resistivity.

According to one embodiment of the present invention, the glass sheet may comprise means to selectively filtering the infrared from sun radiation, and the LiDAR sensor is placed on the internal face of the glass sheet in a zone free of the infrared filter.

According to a preferred embodiment of the invention, the glass sheet is a laminated glass element comprising an exterior and an interior glass sheets laminated with at least one thermoplastic interlayer and wherein the exterior and an interior glass sheets are high level of near infrared radiation transmission glass sheets having an absorption coefficient lower than 5 m⁻¹ in the wavelength range from 750 to 1650 nm, preferably from 750 to 1050 nm, and more preferably from 750 to 950 nm.

The glass sheet according to the invention can have a thickness varying between 0.1 and 5 mm. Advantageously, the glass sheet according to the invention may have a thickness varying between 0.1 and 3 mm. Preferably, for reasons of weight, the thickness of the glass sheet according to the invention is from 0.1 to 2.2 mm.

According to another embodiment of the invention, the at least one glass element is made of heat treated glass sheet, for example annealed or tempered and/or bended glass sheet. Typically, this involves heating the glass sheet (coated or not) in a furnace to a temperature of at least 580° C., more preferably of at least about 600° C. and still more preferably of at least 620° C. before rapidly cooling down the glass substrate. This tempering and/or bending can take place for a period of at least 4 minutes, at least 5 minutes, or more in different situations.

According to another embodiment of the present invention, the glass sheet is a tinted glass.

According to one embodiment of the present invention, the glass sheet has a value of light transmission lower than the value of infrared transmission. Particularly, according to another embodiment of the present invention, the value of light transmission in the visible range is lower than 10% and the value of near infrared transmission is higher than 50%.

According to another advantageous embodiment of the invention, the glass sheet is covered with at least one IR transparent absorbing (tinted) and/or reflecting coating in order to hide the un-aesthetic element of the sensor from the outside while ensuring a good level of operating performances. This coating may, for example, be composed of at least one layer of black ink having no (or very low) transmission in the visible optical range but having a high transparency in the infrared range of interest for the application. Such ink can be made of organic compounds as, for example, commercial products manufactured by Seiko Advance Ltd. Or Teikoku Printing Ink Mfg. Co. Ltd. that can achieve transmission <5% in the 400-750 nm range and >70% in the 850-950 nm range. The coating may be provided on face(s) 1 or/and 2 for a single automotive glazing element or on face(s) 1 or/and 4 for a laminated automotive glazing, depending of its durability.

According to another embodiment of the invention, the glass sheet may be covered with a multilayer coating optimized to reflect selectively the visible range while maintaining high IR transmission. Some properties such as observed on Kromatix® product are thus sought. These properties ensure a total low IR absorbance of the complete system when such layer is deposited on adequate glass composition. The coating may be provided on face(s) 1 or/and 2 for a single automotive glazing element or on face(s) 1 or/and 4 for a laminated automotive glazing, depending of its durability.

According to the present invention, a LiDAR instrument is an optoelectronic system composed of at least a laser transmitter, at least a receiver comprising a light collector (telescope or other optics) and at least a photodetector which converts the light into an electrical signal and an electronic processing chain signal that extracts the information sought.

According to the present invention, a LiDAR sensor emits and/or receives p-polarized laser signal. More generally, the laser signal should include p-polarized signal as much as possible, preferably more than 50%, more preferably more than 70%.

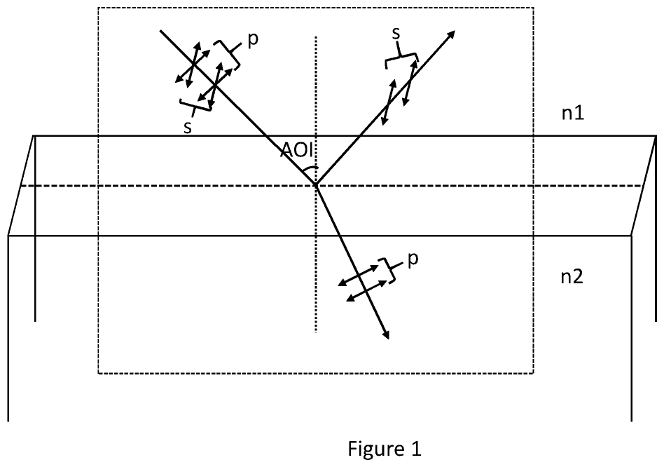

It is well known that laser signal is inherently electromagnetic wave with electric field and magnetic field, which are both perpendicular to the wave propagation direction. As shown in FIG. 1, if the laser signal encounters an interface between two materials with two different refractive indices n1 and n2, it forms a place of incidence with the surface normal. P-polarized signal means that the electric field is parallel to the plane of incidence, while the other polarization having the electric field perpendicular to the plane of incidence is defined as s-polarized signal.

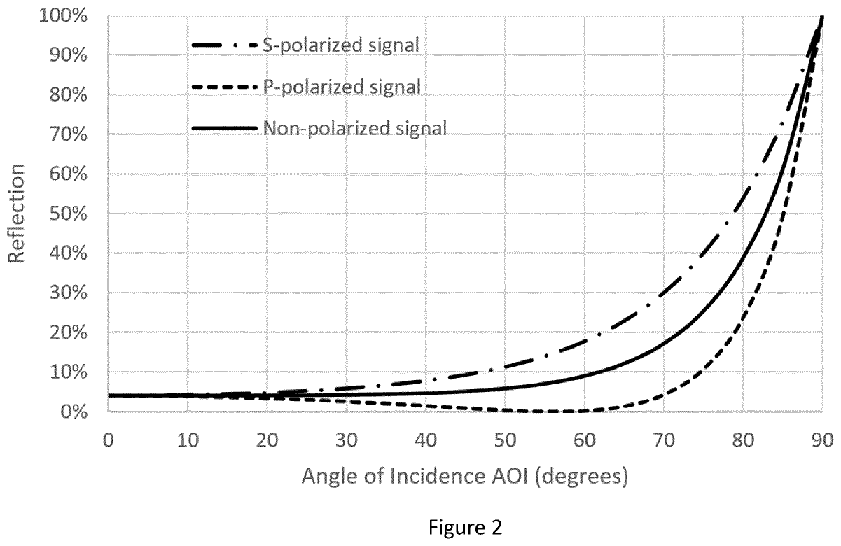

According to Fresnel reflection equations, the surface reflection loss at air (n1=1) and glass (n2=1.5) interface for signal with different polarizations are calculated and plot in FIG. 2 representing the reflection at air (n1=1) and glass (n2=1.5) interface for signal with different polarizations. It clearly shows that p-polarized signal has minimized reflection loss at large AOIs, comparing with s-polarized signal or non-polarized signal. Taken windshield integration as an example, the installation angle of a windshield is typically between 25 and 40 degrees. A LiDAR sensor is normally placed at the top part of the windshield, hence the local inclined angle can be even smaller, e.g. from 20 to 35 degrees. The nominal AOI of the signal is the complementary angle of the local inclined angle, which can be from 55 to 70 degrees. Referring to FIG. 2, the reflection loss for p-polarized signal can be reduced from 7% up to 13%, compared with non-polarized signal. Taken into considerations of 20-degree Field of View (FOV) of the detector, the maximum AOI can go up to 80 degrees, and the reflection reduction loss can be up to 15%.

For emitted signal going through automotive LiDAR glazing, there are two times surface reflection loss, at inner and outer surfaces, which means that the reduction of signal loss by p-polarized signal should be roughly doubled. If the received LiDAR signal can be p-polarized as well, the introduced signal loss reduction is even enhanced.

If an AR coating is needed to be applied, the design of the AR coating for p-polarized signal only is also easier than the design for signal with other polarizations.

The LiDAR is placed on the internal face of the glass sheet (namely face 2) in case of one glass sheet glazing.

According to another embodiment of the present invention, the automotive LiDAR glazing is a laminated glazing wherein the LiDAR is placed on the internal face of the inner glass sheet namely the face 4.

According to a preferred embodiment of the present invention, the automotive glazing is a windshield. Thus, the infrared-based remote sensing device is placed on face 4 of the windshield on a zone free of infrared reflective layer. Indeed, in case of an infrared reflective coating, a zone free of coating is provided for example by decoating or by masking in a way that the LiDAR is positioned on this area without coating on face 4 (or on face 2 in case of one glass sheet glazing) to insure its functionalities. The coating free area has generally the shape and dimensions of the infrared-based remote sensing device. In case of an infrared absorbing film, the film is cut in the dimensions of the LiDAR that the LiDAR is positioned on this area without film to insure its functionalities.

According to one embodiment of the present invention, the automotive glazing is ultrathin glazing.

Advantageously, the IR-based remote sensing device is optically coupled to the internal face of the glazing. For example, a soft material that fits refractive index of the glass and the external lens of the LiDAR may be used.

According to another advantageous embodiment of the invention, the glass sheet is coated with at least one antireflection layer. An antireflection layer according to the invention may, for example, be a layer based on porous silica having a low refractive index or it may be composed of several layers (stack), in particular a stack of layers of dielectric material alternating layers having low and high refractive indexes and terminating in a layer having a low refractive index. Such coating may be provided on face(s) 1 or/and 2 for a single glazing” or on face(s) 1 or/and 4 for a laminated glazing. A textured glass sheet may be also used. Etching or coating techniques may as well be used in order to avoid reflection.

1. An automotive glazing comprising at least one glass sheet having an absorption coefficient lower than 5 m⁻¹ in a wavelength range from 750 to 1650 nm and having an external face and an internal face, wherein an infrared-based remote sensing device emitting and/or receiving p-polarized laser signals in the wavelength range from 750 to 1650 nm, is placed on the internal face of the glass sheet.

2. The automotive glazing according to claim 1, wherein the glass sheet has an absorption coefficient lower than 1 m⁻¹.

3. The automotive glazing according to claim 1, wherein the infrared-based remote sensing device is optically coupled to the internal face of the glazing.

4. The automotive glazing glazing according to claim 1, wherein the glazing is a laminated glazing comprising exterior and an interior glass sheets laminated with at least one thermoplastic interlayer and wherein the exterior and an interior glass sheets are high level of near infrared radiation transmission glass sheets having an absorption coefficient lower than 5 m⁻¹ and wherein the infrared-based remote sensing device is placed on a face 4.

5. The automotive glazing according to claim 4 wherein a value of light transmission of the glazing is lower than a value of near infrared transmission of the glazing.

6. The automotive glazing according to claim 1, wherein the glass sheet is covered with at least one near-infrared transparent coating that absorbs and/or reflects the visible light.

7. The automotive glazing according to claim 1 wherein the glass sheet comprises a content, expressed as the total weight of glass percentages:
total iron (expressed as Fe₂O₃) 0.002 to 0.06%
Cr₂O₃ 0.0001 to 0.06%.

8. The automotive glazing according to claim 1 wherein the glass sheet comprises a content, expressed as the total weight of glass percentages:
total iron (expressed as Fe₂O₃) 0.002 to 0.06%
Cr₂O₃ 0.0015 to 1%
Co 0.0001 to 1%.

9. The automotive glazing according to claim 1, wherein the glass sheet comprises a content, expressed as the total weight of glass percentages:
total iron (expressed as Fe₂O₃) 0.02 to 1%
Cr₂O₃ 0.002 to 0.5%
Co 0.0001 to 0.5%.

10. The automotive glazing according to claim 1, wherein the glass sheet comprises a content, expressed as the total weight of glass percentages:
total iron (expressed as Fe₂O₃ Fe2O3) from 0.002 to 1%
Cr₂O₃ Cr2O3 0.001 to 0.5%
Co 0.0001 to 0.5%
Se 0.0003 to 0.5%.

11. The automotive glazing according to claim 1, wherein the automotive glazing is provided at least partially with an infrared filter and wherein the infrared-based remote sensing device and a LiDAR sensor is located in a the zone of glazing free of the infrared filter.

12. The automotive glazing according to claim 11, wherein the infrared filter is a coating and wherein a decoating zone is provided on which the infrared-based remote sensing device is placed.

13. The automotive glazing according to claim 1, wherein the infrared-based remote sensing device is a LIDAR system based on scanning, rotating, flashing or solid state LiDARs and enabling of 3D mapping the surroundings around the vehicle.

14. The automotive glazing according to claim 1, wherein the automotive glazing is a windshield or a glass trim element as a cover for A-, B- and C-pillar or a cover for a trunk of a motor vehicle or a part of a cover lens for a protective housing of the LiDAR sensor.
